(19) United States
(12) Patent Application Publication
(10) Pub. No.: US 2018/0271197 A1
(43) Pub. Date: Sep. 27, 2018

(54) ILLUMINATION HEADBAND

(71) Applicant: Garry Stephen Lane, II, Rochester Hills, MI (US)

(72) Inventor: Garry Stephen Lane, II, Rochester Hills, MI (US)

(21) Appl. No.: 15/937,815

(22) Filed: Mar. 27, 2018

Related U.S. Application Data
(60) Provisional application No. 62/477,397, filed on Mar. 27, 2017.

(51) Int. Cl. A42B 1/24; A41D 20/00; F21V 33/00; F21L 4/02

(52) U.S. Cl. CPC A42B 1/242; A41D 20/00; F21Y 2105/00; F21L 4/02; F21V 33/0008

(57) ABSTRACT

An illumination device for wear around a head of a user. The illumination device includes a headband, a circuit-board, a plurality of push-panels and a power-unit. In a preferred embodiment, the plurality of push-panels includes a plurality of LED lights around a continuous-length of the headband. The illumination device is useful for 360-degree illumination, particularly in low-light conditions.

### CROSS REFERENCE TO RELATED APPLICATION

The present application is related to and claims priority to U.S. Provisional Patent Application No. 62/477,397 filed Mar. 27, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of illuminated apparel and more specifically relates to a headband including illumination means.

### 2. Description of Related Art

Each year, thousands of cyclists, walkers and joggers are struck by a motor vehicle causing serious injury or death. Up to half of these accidents occur when they are struck by a vehicle that is approaching them from either the front or the side. For example, a bicyclist proceeding down a road is struck by an oncoming vehicle which makes a left turn into the path of the bicyclist. In many of these cases, low visibility is to blame. Some people may carry a flashlight, but this can be restrictive. Other people may wear a headlamp to free up their hands, but such devices shine light in only one direction, restricting wearers' visibility. Additionally, drivers may not see people or animals walking on the side or roads in such conditions, causing accidents, injuries, and even death. An effective alternative is needed.

U.S. Pub. No. 2016/0088890 to Caffey Armagh relates to an illuminated sweat band. The described illuminated sweat band includes a head band consisting of a fabric layer adjustably wearable around a head of a user for absorbing sweat and an electroluminescent panel removably attachable to an outer surface of the fabric layer by a fastening member. The illuminated sweatband further comprises a portable inverter housing a battery unit and a switching control, operatively connected to the electroluminescent panel. Actuating the electroluminescent panel via the switching control illuminates the entire surface area of the head band, thus making the user more visible, especially under dimly lit or dark environment.

### BRIEF SUMMARY OF THE INVENTION

In view of the foregoing disadvantages inherent in the known illuminated apparel art, the present disclosure provides a novel illumination headband. The general purpose of the present disclosure, which will be described subsequently in greater detail, is to provide a headband for wear around a head of a user to provide effective and efficient 360-degree illumination.

An illumination device is disclosed herein. The illumination device includes a headband which may comprise a continuous-length defined by an inner-surface and outer-surface; the inner-surface being configured for contact with the head of the user. Further, a circuit-board may disposed within the headband and may include a plurality of circuit contact-points. A plurality of push-panels may be attached to the outer-surface of the headband and in electrical-communication with the circuit-board. Each of the plurality of push-panels may include at least one panel contact-point and at least one light therein and each at least one panel contact-point may be configured for selective-contact with at least one of the plurality of circuit contact-points. The selective-contact may be configured to provide illumination to the at least one light. In addition, a power-unit may be disposed within the headband and configured to provide power to the at least one circuit-board.

A method of using the illumination device is also disclosed herein. The method of using the illumination device may comprise the steps of: providing the illumination device as above; placing the inner-surface of the continuous-length over the head of the user to attach the headband to the head of the user; and pushing at least one of the plurality of push-panels to actuate the selective-contact and provide the illumination to the at least one light.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an illumination headband, constructed and operative according to the teachings of the present disclosure.

FIG. 1 is a side perspective view of the illumination device during an ‘in-use’ condition, according to an embodiment of the disclosure.

FIG. 2 is a front perspective view of the illumination device of FIG. 1, according to an embodiment of the present disclosure.

FIG. 3A is a top perspective view of the illumination device of FIG. 1, according to an embodiment of the present disclosure.

FIG. 3B is a front perspective view of the illumination device of FIG. 1, according to an embodiment of the present disclosure.

FIG. 4A is a front perspective view of the illumination device of FIG. 1, according to an embodiment of the present disclosure.

FIG. 4B is a front perspective view of the illumination device of FIG. 1, according to an embodiment of the present disclosure.

FIG. 5 is a rear perspective view of the illumination device of FIG. 1, according to an embodiment of the present disclosure.

FIG. 6 is a flow diagram illustrating a method of use for the illumination device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to illuminated apparel and more particularly to an illumination headband as used to improve the headband including novel illumination means.

Generally disclosed is a device to provide a safe and convenient way to illuminate a path at night or in lowlight conditions, eliminating the need to wear traditional headlamps, which limit wearers' range of vision. The device may allow driver to see wearers of the device on the side of the road for increased safety, and may free up hands of the wearers. The device may include a rechargeable battery pack for use virtually anywhere. Further, the device may include a headband, made from elastic fabric or other suitable material to accommodate people of varying head sizes. A number of panels may be provided around an exterior of the headband, and each panel may include various LED lights for 360-degree illumination. Optionally, the panels on the back may illuminate red, mimicking a vehicle's rear headlights. In use, the wearers may apply a gentle push to turn on each panel individually. A second push may turn off the panels. On a back of the headband may be the rechargeable battery pack and a recharging port. The exact specifications may vary upon manufacturing.

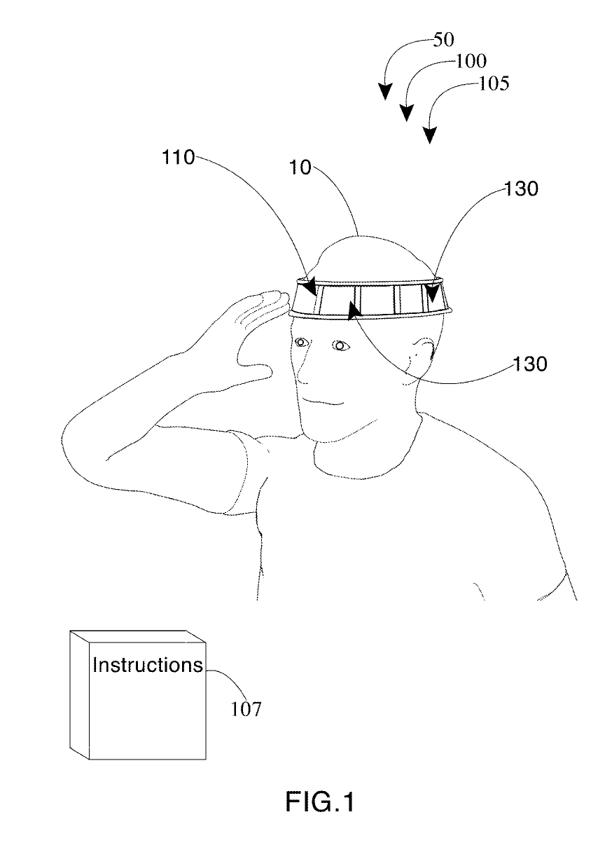

Referring now more specifically to the drawings by numerals of reference, there is shown in FIGS. 1-5, various views of an illumination device 100.

FIG. 1 shows an illumination device 100 during an ‘in-use’ condition 150, according to an embodiment of the present disclosure. As Illustrated, the illumination device 100 may include a headband 110, a circuit-board 120, a plurality of push-panels 130, and a power-unit 140. As shown, the illumination device 100 may be configured for wear around a head of a user 10.

According to one embodiment, the illumination device 100 may be arranged as a kit 105. The kit 105 may include a set of user instructions 107. The instructions 107 may detail functional relationships in relation to the structure of the illumination device 100 (such that the illumination device 100 can be used, maintained, or the like, in a preferred manner).

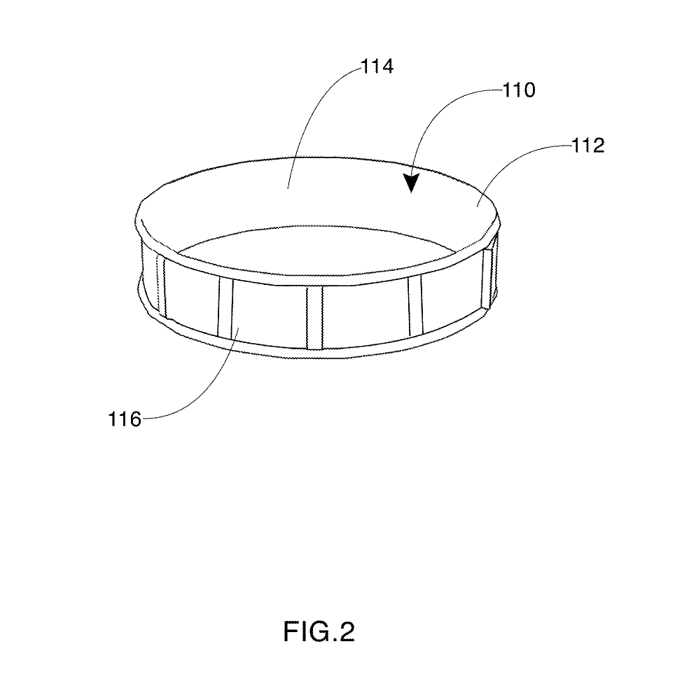

FIG. 2 shows a front perspective view of the illumination device 100 of FIG. 1, according to an embodiment of the present disclosure. As illustrated, the headband 110 may include a continuous-length 112 being defined by an inner-surface 114 and outer-surface 116, the inner-surface 114 being configured for contact with the head of the user 10. The headband 110 may be made from a fabric-material and in a preferred embodiment may include an elastic-material to accommodate a variety of head-sizes.

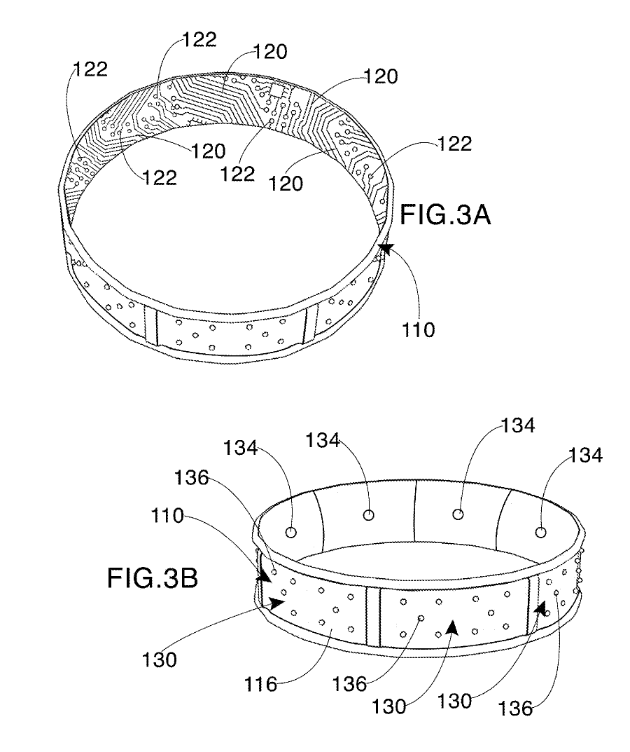

Referring now to FIG. 3A and FIG. 3B showing respectively a top perspective view and a front perspective view of the illumination device 100 of FIG. 1, according to an embodiment of the present disclosure. As shown, the circuit-board 120 may be disposed within the headband 110, the circuit-board 120 including a plurality of circuit contact-points 122. Further, the plurality of push-panels 130 may be attached to the outer-surface 116 of the headband 110 and in electrical-communication 132 with the circuit-board 120, each of the plurality of push-panels 130 including at least one panel contact-point 134 and at least one light 136 therein, each at least one panel contact-point 134 being configured for selective-contact with at least one of the plurality of circuit contact-points 122. The circuit-board 120 may be a printed circuit board which electrically connects electronic components or electrical components using conductive tracks, pads and other features (here, the plurality of circuit contact-points 122) etched from sheet layers of copper laminated onto sheet layers of a non-conductive substrate. The printed circuit board may single-sided, double-sided or multi-layer.

In a preferred embodiment, a total number of the panel contact-points 134 may be equal to a total number of the circuit-contact points 122 such that each panel contact-point 134 may have a corresponding circuit-contact point 122. In a preferred embodiment, the plurality of push-panels 130 may comprise ten panels. The panel contact-points 134 may include conductive material configured to electrically connect the panel contact-points 134 with the circuit-contact points 122.

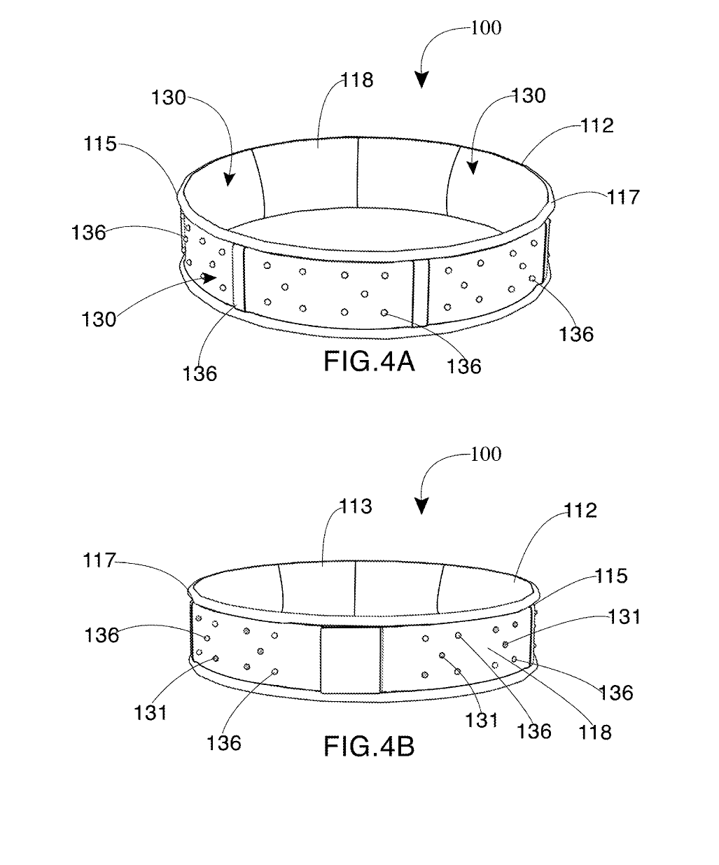

FIG. 4A and FIG. 4B show front perspective views of the illumination device 100 of FIG. 1, according to an embodiment of the present disclosure. The continuous-length 112 may include a front-side 113, a left-side 115, a right-side 117 and a rear-side 118 relative to the user 10 when the headband 110 is worn on the head of the user 10. In addition to this, the plurality of push-panels 130 may be located on the front-side 113, the left-side 115, the right-side 117 and the rear-side 118 of the continuous-length 112 to provide the 360-degree illumination.

The selective-contact between the panel contact-point 134 and the circuit contact-point 122 may be configured to provide illumination to the at least one light 136. In the preferred embodiment, the selective-contact may be actuated via a manual push by the user 10. Further, in the preferred embodiment, the at least one light 136 may comprise a plurality of lights 136. Further, the plurality of lights 136 may be light 136 emitting diode (LED) lights 136. However, it should be appreciated that other lights 136 or other means of illumination may be used.

The plurality of push-panels 130 located on the rear-side 118 of the continuous-length 112 may each include the at least one light 136. In one preferred embodiment, the at least one light 136 may be configured to illuminate in a warning color 131. In one embodiment, the warning color 131 may be red. However, other colors may be used. Further to this, the plurality of push-panels 130 located on the front-side 113, the left-side 115 and the right-side 117 of the continuous-length 112 may each include the at least one light 136 and may be configured to illuminate in a white color.

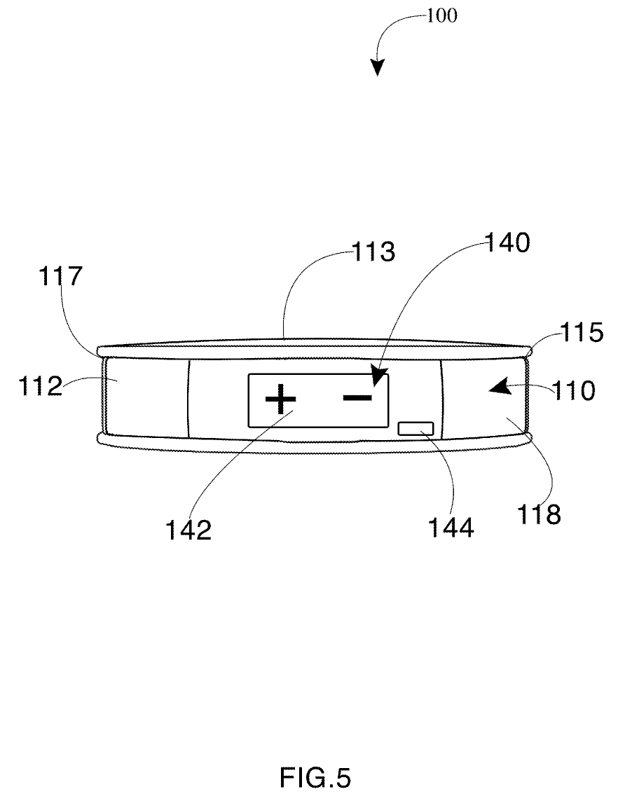

FIG. 5 shows a rear perspective view of the illumination device 100 of FIG. 1, according to an embodiment of the present disclosure. As shown, the power-unit 140 may be disposed within the headband 110 and configured to provide power to the at least one circuit-board 120. The power-unit 140 may include a rechargeable battery 142 and a power-inlet 144 configured to provide charge to the rechargeable battery 142. Further to this, as shown, the power-unit 140 may be located on the rear-side 118 of the continuous-length 112. However, it should be appreciated that the power-unit 140 may be located within the continuous-length 112 or at any point on the front-side 113, left-side 115 or right-side 117 of the continuous-length 112.

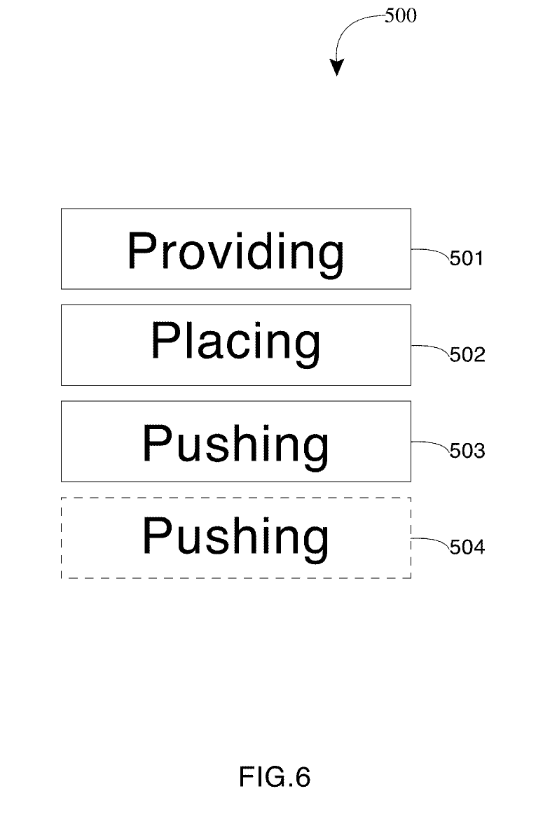

Referring now to FIG. 6, a flow diagram illustrating a method of using an illumination device for wear around a head of user 500, according to an embodiment of the present disclosure. As illustrated, the method of using an illumination device for wear around a head of user 500 may include the steps of: step one 501, providing the illumination device 100 as above; step two 502, placing the inner-surface 114 of the continuous-length 112 over the head of the user 10 to attach the headband 110 to the head of the user 10; and step three 503 pushing at least one of the plurality of push-panels 130 to actuate the selective-contact and provide the illumination to the at least one light 136. A further step may include: step four 504, pushing the at least one of the plurality of push-panels 130 to break the selective-contact and terminate the illumination to the at least one light 136.

It should be noted that step 504 is an optional step and may not be implemented in all cases. Optional steps of method of use 500 are illustrated using dotted lines in FIG. so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for illumination device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An illumination device for wear around a head of a user, the illumination device comprising:
a headband including a continuous-length being defined by an inner-surface and outer-surface, the inner-surface being configured for contact with the head of the user;
a circuit-board disposed within the headband, the circuit-board including a plurality of circuit contact-points;
a plurality of push-panels attached to the outer-surface of the headband and in electrical-communication with the circuit-board, each of the plurality of push-panels including at least one panel contact-point and at least one light therein, each at least one panel contact-point being configured for selective-contact with at least one of the plurality of circuit contact-points, and wherein the selective-contact is configured to provide illumination to the at least one light; and
a power-unit disposed within the headband, the power-unit configured to provide power to the at least one circuit-board.

2. The illumination device of claim 1, wherein the at least one light comprises a plurality of lights.

3. The illumination device of claim 2, wherein the plurality of lights are light emitting diode (LED) lights.

4. The illumination device of claim 1, wherein the plurality of push-panels comprise ten panels.

5. The illumination device of claim 1, wherein a total number of the panel contact-points is equal to a total number of the circuit-contact points.

6. The illumination device of claim 1, wherein the selective-contact is actuated via a manual push by the user.

7. The illumination device of claim 1, wherein the continuous-length includes a front-side, a left-side, a right-side and a rear-side relative to the user when the headband is worn on the head of the user.

8. The illumination device of claim 7, wherein the plurality of push-panels on the front-side, the left-side, the right-side and the rear-side of the continuous-length.

9. The illumination device of claim 8, wherein the plurality of push-panels located on the rear-side of the continuous-length each include the at least one light, and wherein the at least one light is configured to illuminate in a warning color.

10. The illumination device of claim 9, wherein the warning color is red.

11. The illumination device of claim 8, wherein the plurality of push-panels located on the front-side, the left-side and the right-side of the continuous-length each include the at least one light, and wherein the at least one light is configured to illuminate in a white color.

12. The illumination device of claim 1, wherein the power-unit includes a rechargeable battery.

13. The illumination device of claim 12, wherein the power-unit further includes a power-inlet configured to provide charge to the rechargeable battery.

14. The illumination device of claim 13, wherein the power-unit is located on the rear-side of the continuous-length.

15. The illumination device of claim 1, wherein the headband is made from a fabric-material.

16. The illumination device of claim 16, wherein the headband includes an elastic-material to accommodate a variety of head-sizes.

17. An illumination device for wear around a head of a user, the illumination device comprising:
a headband including a continuous-length being defined by an inner-surface and outer-surface, the inner-surface being configured for contact with the head of the user;
a circuit-board disposed within the headband, the circuit-board including a plurality of circuit contact-points;
a plurality of push-panels attached to the outer-surface of the headband and in electrical-communication with the circuit-board, each of the plurality of push-panels including at least one panel contact-point and at least one light therein, each at least one panel contact-point being configured for selective-contact with at least one of the plurality of circuit contact-points, and wherein the selective-contact is configured to provide illumination to the at least one light; and
a power-unit disposed within the headband, the power-unit configured to provide power to the at least one circuit-board; and
wherein the at least one light comprises a plurality of lights;
wherein the plurality of lights are light emitting diode (LED) lights;
herein the plurality of push-panels comprise ten panels;
wherein a total number of the panel contact-points is equal to a total number of the circuit-contact points;
wherein the selective-contact is actuated via a manual push by the user;
wherein the continuous-length includes a front-side, a left-side, a right-side and a rear-side relative to the user when the headband is worn on the head of the user;
wherein the plurality of push-panels on the front-side, the left-side, the right-side and the rear-side of the continuous-length;
wherein the plurality of push-panels located on the rear-side of the continuous-length each include the at least one light, and wherein the at least one light is configured to illuminate in a warning color;
wherein the warning color is red;
wherein the plurality of push-panels located on the front-side, the left-side and the right-side of the continuous-length each include the at least one light, and wherein the at least one light is configured to illuminate in a white color;
wherein the power-unit includes a rechargeable battery;
wherein the power-unit further includes a power-inlet configured to provide charge to the rechargeable battery;
wherein the power-unit is located on the rear-side of the continuous-length;
wherein the headband is made from a fabric-material; and
wherein the headband includes an elastic-material to accommodate a variety of head-sizes.

18. The illumination device of claim 17, further comprising set of instructions; and
wherein the illumination device is arranged as a kit.

19. A method of using an illumination device for wear around a head of user, the method comprising the steps of:
providing the illumination device for wear around the head of the user, the illumination device including:
a headband including a continuous-length being defined by an inner-surface and outer-surface, the inner-surface being configured for contact with the head of the user;
a circuit-board disposed within the headband, the circuit-board including a plurality of circuit contact-points;
a plurality of push-panels attached to the outer-surface of the headband and in electrical-communication with the circuit-board, each of the plurality of push-panels including at least one panel contact-point and at least one light therein, each at least one panel contact-point being configured for selective-contact with at least one of the plurality of circuit contact-points, and wherein the selective-contact is configured to provide illumination to the at least one light;
a power-unit disposed within the headband, the power-unit configured to provide power to the at least one circuit-board;
placing the inner-surface of the continuous-length over the head of the user to attach the headband to the head of the user; and
pushing at least one of the plurality of push-panels to actuate the selective-contact and provide the illumination to the at least one light.

20. The method of claim 19, further comprising the step of:
pushing the at least one of the plurality of push-panels to break the selective-contact and terminate the illumination to the at least one light.
